(19) United States
(12) Patent Application Publication
(10) Pub. No.: US 2026/0293925 A1
(43) Pub. Date: Oct. 1, 2026

(54) Biomanufacturing of Isolated and Sterilized Kefir Whey Bioactive Metabolites

(71) Applicant: Carlos A Sierra, Smithfield, NC (US)

(72) Inventor: Carlos A Sierra, Smithfield, NC (US)

(21) Appl. No.: 19/094,994

(22) Filed: Mar. 30, 2025

(51) Int. Cl. A23C 21/00; A01J 25/11; A23B 11/16

(52) U.S. Cl. CPC A23C 21/00; A01J 25/117; A23B 11/164; A23C 2210/202

(57) ABSTRACT

A method and apparatus for providing isolated and sterilized whey from kefir grains by placing the kefir grains in a vessel, adding a mammalian milk to the vessel, and fermenting the kefir grains for 48 hours. Kefir grains are removed from the vessel and the fermentation process is continued for 48 to 96 hours. Whey is separated from the curd by draining the whey from the bottom of the vessel and by filtering out the curd. The whey is then filtered with micron filters ranging from 0.8 to 1.2 microns to remove microbes and micro kefir and curd. The whey is then sterilized with UV-C light to kill any remaining probiotics. The resulting kefir isolated and sterilized whey is suitable for topical use in cosmetics and as an ingredient in pharmaceutical formulations, food, and beverages.

### FIELD OF THE DISCLOSURE

This disclosure is related to methods of fermenting kefir grains and, more particularly, to fermenting kefir grains, isolating the whey from the curd, making the whey safe and stable for pharmaceutical, cosmetic, food, and beverage uses.

### BACKGROUND OF THE DISCLOSURE

Kefir is a fermented drink with a yogurt-like texture usually produced by inoculating and fermenting animal milk such as cow milk or goat milk using kefir grains in a fermenting container. A fermentable sugar is introduced into the container along with the kefir grains. A curd is allowed to gather at the top of the container, so as to form a fermentation composition. The fermentation composition is allowed to ferment until the kefir grains have accumulated towards the top along with the curd and whey liquid forms underneath, which is known as the separation process during fermentation. The whey liquid demonstrates antimicrobial activity and has a pH of about 3.0 (see U.S. Pat. No. 11,712,053). Whey has nutritional value when consumed in terms of nutrients needed for human growth and development along with other bioactive metabolites that have been shown in scientific literature to be beneficial for humans in many organ systems.

There are no disclosures in the prior art for the topical treatment of skin with kefir whey formulations nor any disclosures of methods to formulate kefir whey for topical and cosmetic use, along with food and beverages and pharmaceutical formulations. Because of the existence of nutrients, anti-inflammatory, anti-microbial and anti-carcinogenic chemical compounds in kefir whey it is desirable to have a practical method for preparing isolated and sterilized kefir whey for safe and effective topical use on the skin in addition to pharmaceutical, food, and beverage uses.

### SUMMARY OF THE DISCLOSURE

This disclosure describes a method of providing isolated and sterilized whey from kefir grains. Kefir grains are placed in a vessel and mammalian milk is added to the vessel in a ratio of 1 gallon of mammalian milk per 40 to 60 grams of kefir grains. The kefir grains are fermented (a first fermentation known as F1) for 36 to 56 hours, preferably 48 hours. Kefir grains are removed from the vessel and kefir resumes fermentation (a second fermentation known as F2) for 48 to 96 hours. The whey is separated from the curd and is filtered through a micron filter ranging in pore size from 0.8 to 120 microns. The whey is then sterilized with UV-C light ranging from 100 to 280 nm.

Separating the whey from the curd is performed by first removing whey from the bottom of the vessel. The whey is filtered first through an 80-120 micron filter, then second through a 25-35 micron filter, then third through an 18-22 micron filter, then fourth through an 8-12 micron filter, then fifth through a 4-6 micron filter, and then sixth through a 0.8 to 1.2 micron filter.

Alternatively, separating the whey from the curd is performed by first filtering the Kefir with a microfilter having a pore size of 80 to 120 microns. The filtered whey is then filtered first through a 25-35 micron filter, then second through an 18-22 micron filter, then third through a 8-12 micron filter, then fourth through a 4-6 micron filter, and then fifth through a 0.8 to 1.2 micron filter.

The kefir grains may be obtained from a previous fermentation of kefir grains. Starch, fermentable foods, or sugars, or a combination thereof may be added to the first fermentation. Precursor nutrients, starches, whey protein, and any fermentable sugars, or a combination thereof may be added to the second fermentation.

This disclosure provides an apparatus for isolating whey from a mixture of curds and whey. A first container has a top, a bottom, and an interior wherein the first container contains a mixture of curds and whey. A micron filter is positioned in the interior of the first container wherein the micron filter has a top, a bottom, and an interior. A sealing member is used to seal the top end of the microfilter to the top end of the first container. The first container is positioned in a second container so as to cause whey in the mixture of curds and whey to pass through the micron filter into the interior of the micron filter and into the interior of the second container while the curd remains in the interior of the first container. The sealing apparatus closes and seals the top of the first container and leaves the top of the microfilter open. The first container is positioned in the second container, preferably in an inverted position.

This disclosure provides an apparatus for filtering and sterilizing whey first separated from curd wherein the whey is contained in a holding container. The holding container has an output port connected with conduit to an input port of a first microfilter in a series of microfilters. An output port of a last microfilter in the series of microfilters is connected with conduit to an input port on a sterilizer. A pump is positioned anywhere between the holding container and the receiving container. An output port on the sterilizer is connected to an input port on a receiving container. The pore size of the microfilters ranges, preferably, from 25-35 microns of the first microfilter in the series of microfilters to 0.8 to 1.2 microns of the last microfilter in the series of microfilters. The sterilizer is, preferably, a UV-C light sterilizer. The receiving container is, preferably, sterilized. The pump is, preferably, positioned between the output of the last microfilter in the series and the input of the sterilizer.

An advantage of this method and the apparatuses is the isolation of kefir whey from the curd through filtrations from 100 micron down to 1 micron, effectively isolating the nutrients, including primary and secondary bioactive metabolites in the nanometer range, followed by sterilization with UV-C light ranging from 100 to 280 nm.

Another advantage is sterilized kefir whey containing no living microorganisms.

Another advantage is sterilized kefir whey that is suitable for topical application on subjects via cosmetic use.

Another advantage is sterilized kefir whey anti-microbial and anti-cancer bioactive metabolites that are suitable for pharmaceutical formulations.

Another advantage is sterilized kefir whey nutrients and bioactive metabolites suitable for food and drink formulations.

### BRIEF DESCRIPTION OF THE DRAWINGS

FIG. 1 is a flow chart illustrating the fermentation of kefir whey of this disclosure.

FIG. 2 is a flow chart illustrating the isolation and sterilization of the kefir whey.

FIG. 3 is a chart illustrating the development of the kefir whey in the pharmaceutical, cosmetic, and food and beverage industries.

FIG. 4A shows components for an apparatus for isolating whey from kefir.

FIG. 4B shows a 100 micron filter placed in a first container wherein the first container will contain Kefir.

FIG. 4C shows the first container placed inverted into the second container, thereby causing the whey in the kefir to flow through the 100 micron filter and into the second container.

FIG. 5 shows an apparatus for filtering and sterilizing the whey.

### DETAILED DESCRIPTION OF THE DISCLOSURE

While the following description details the preferred embodiments of the present disclosure, it is to be understood that the invention is not limited in its application to the details of compositions or steps of methods illustrated in the accompanying figures, since the compositions and methods are capable of other embodiments and of being practiced in various ways.

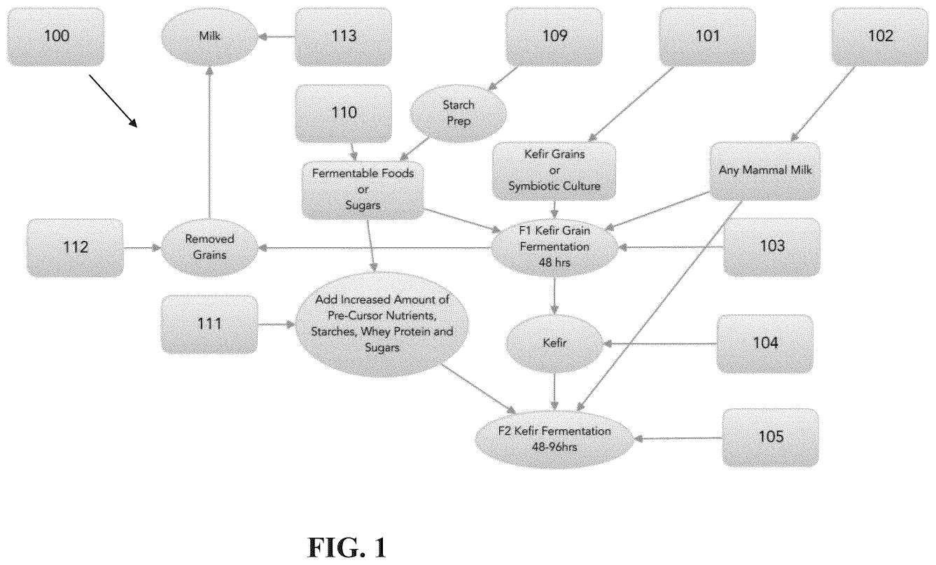

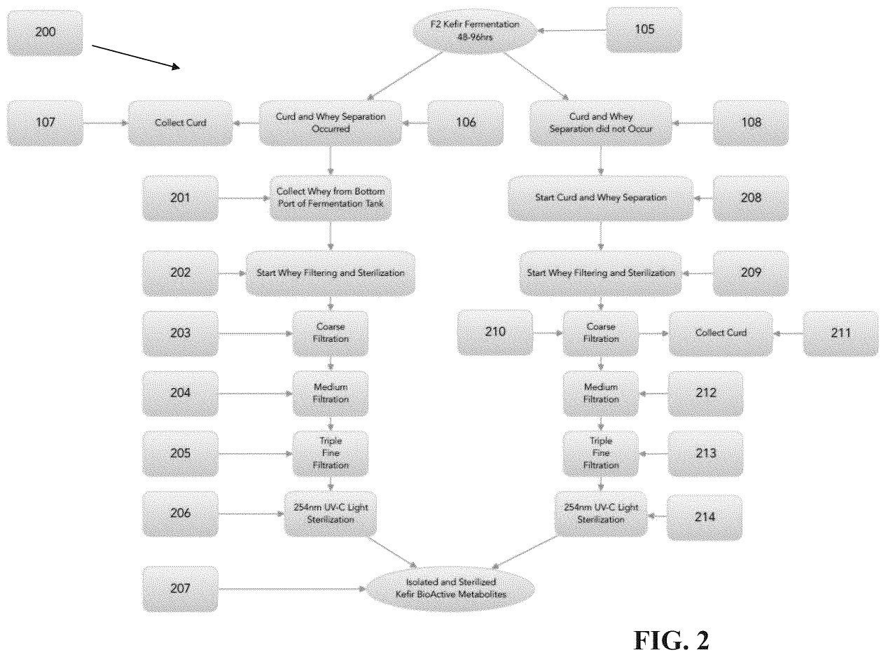

FIG. 1 is a flow chart 100 illustrating the fermentation of kefir whey. Kefir grains 101 are a symbiotic culture and are a colony of numerous strains of probiotic bacteria and numerous strains of probiotic yeast living in symbiosis. Kefir grains from different regions of the earth contain slightly different strains of probiotics. The kefir grains have no known origin by scientist and researchers and the probiotics did not make them in the beginning of their origin. The probiotics can only add more exopolysaccharide known as Kefiran, to make them grow in size while micronized pieces bud off and create a new grain and the probiotics build upon that new smaller grain to multiply the grains in number and in size per fermentation cycle. Kefir grains 101 are used in any amount from 12.5 grams of kefir grains per quart of mammalian milk to 50 grams of kefir grains per gallon of mammalian milk. As long as enough kefir grains are used to match the volume of mammalian milk used, fermentation of the milk will occur. Once placed in a fermentation vessel of any volume, from a one quart vessel to a 500 gallon vessel, and as long as the amount of grams of kefir grains properly match the vessel volume, fermentation of the milk will occur. For example, a 1,000 gallon volume of mammalian milk requires 50,000 grams of kefir grains. Kefir grains are commercially available and any type of grains from any country can be used. Any type of mammalian milk 102 pasteurized or non-pasteurized is added to the fermentation vessel of any size ranging from a one quart to a 1000 gallon size fermentation vessel, but not being limited to these ranges. A first fermentation 103 is allowed to proceed for 36 to 56 hours, preferably 48 hours keeping a temperature of 65 to 75 degrees Fahrenheit or 18.3 Celsius to 24.1 Celsius. The vessel is stirred or agitated manually with a paddle or any size spatula, or an automatic electric motor with stirring rod or paddle or the like mounted on top of the 1,000 gallon vessel. After the first fermentation 103 kefir grains 104 are removed from the fermentation vessel and a second fermentation F2 105 is allowed to proceed for 36 to 110 hours, preferably 48-96 hours. The curd is collected 108 (see FIG. 2) as a byproduct and can be used in food and beverage formulations. In other cases, the whey will not separate 108 from the curd.

If desired, after the first fermentation 103 the kefir grains can be removed 112 by utilizing a 60 mesh filter or strainer with a pore size of 250 microns and used for other kefir fermentations. Removing kefir grains and allowing the kefir to ferment for a second time period known as F2 fermentation, while adding the necessary precursors will produce whey with higher contents of nutrients and bioactive metabolites compared to the first fermentation known as F1. The curd 107 (see FIG. 2) remaining after the removal of the kefir grains is used as food that is made into spreadable cheese or yogurt or used as a food additive in smoothies or protein shakes for the added benefits of probiotics and nutrients. If desired, starch preparations 109 or fermentable foods or sugars 110 in any amount are added to second 105 fermentation F2.

FIG. 2 is a flow chart illustrating the isolation and sterilization of the kefir whey 200. In the case where curd and whey separation 106 occurred, the whey is collected from the bottom of the fermentation vessel 201. For example, with 2 gallons of fermenting mammalian milk ¾ of a gallon of whey is harvested. By filtering the remaining curd ¼ of a gallon of additional whey is obtained. Thus, fermenting 2 gallons of mammalian milk, 1 gallon of whey can be harvested (produced) while the remaining material is curd which is casein protein. The curd is collected as a byproduct in the usual amount of about half the amount of milk that was used in the fermentation cycle but not limited to this amount. The whey is filtered 202 to remove any micronized kefiran, curd, and microorganisms to improve stability and safety of the whey. A first coarse filtration 203 is performed using a micron filter ranging from 80 to 120 microns, preferably 100 microns, to start the curd and whey separation, thereby forming a first filtrate. The first filtrate then passes through a micron filter ranging from 25-35 microns, preferably 30 microns, thereby forming a second filtrate. A medium filtration 204 of the second filtrate is performed with a micron filter, ranging from 18-22 microns, preferably 20 microns, thereby forming a third filtrate. A fine filtration 205 is performed on the third filtrate with a micron filter, ranging from 8-12 microns, preferably 20 microns, thereby forming a fourth filtrate. Then a second fine filtration is performed on the fourth filtrate with a micron filter, ranging from 4-6 microns, preferably 5 microns, thereby forming a fifth filtrate, and then then a third fine filtration is performed on the fifth filtrate with a micron filter, ranging from 0.8 to 1.2 microns, preferably 1 micron, thereby forming a sixth filtrate. The sixth filtrate of whey is then sterilized 206 with UV-C 254 nm light radiation, in which the lamp is housed within, preferably, a 304 stainless steel housing. The resulting final product is isolated sterilized whey having nutrients with primary and secondary bioactive metabolites 207. Filtering the whey through a series of smaller and smaller pore sizes is a remarkably improved way of removing particulates and impurities from whey and providing a whey of improved clarity. The above process can be scaled to produce any desired amount of isolated sterilized whey.

In the case where separation of curd and whey did not occur 108 the whey is separated from the curd 208 to remove any micronized kefiran, curd and microorganisms to improve stability and safety of the whey. The curd and whey are separated by filtration 209. The whey is filtered out by gravity using half gallon or 1 gallon glass containers. Once accumulated a drain valve is opened to release the whey. The whey is collected in any size plastic HDPE container with a lid and is placed in refrigerator storage at a near freezing temp of 35F if it will be used within a month. Alternatively, the whey may be placed in freezing storage of 30 F for long term storage of 6 months to 1 year. The curd is trapped and collected in the half gallon or gallon container and is removed manually with a spatula or scoop after the filter used for the filtration is removed.

A first, coarse, filtration 210 of the whey is performed with a pore size of 26-36 microns, preferably 30 microns. The remaining curd is collected as a byproduct 211 and can be used in food and beverage formulations. A second, medium, filtration 212 of the whey is performed with a 20 micron filter. A triple fine filtration 213 of the whey is performed with an 8-10 micron filter, preferably 10 microns, then a 4-6 micron filter, preferably 5 microns, and then a 0.8 to 1.2 micron filter, preferably 1 micron, is used. This sequence of filtrations completes the isolation process of the kefir whey. However, this filtration process is not limited to these filters and pore sizes. The isolated filtered whey is then sterilized 214 with UV-C 254 nm light radiation, in which UV-C light falls within the 100-280 nanometer wavelength range, with the most germicidal wavelengths around 254nm. UV-C light which primarily targets the thymine and cytosine bases in DNA, causing them to bond together forming “pyrimidine dimers” which distort the DNA structure and inhibit replication, is highly effective against a wide range of microorganisms including bacteria, yeast and viruses. DNA damage triggers a cascade of cellular events, including the activation of enzymes that dismantle the cell components in a controlled manner, leading to apoptosis of microbes. The UV-C lamp is housed in a 304 stainless steel container and the cold whey at a temperature of 35 degrees Fahrenheit enters the tank by an “inlet” port.

The UV-C light travels through the container and exits at an “out port” of the container and the whey is collected in a disinfected and sterilized 304 stainless steel receiving container as a product that is now “isolated and sterilized kefir whey”. The sterilization insures the elimination of microorganisms which is essential for topical application of the whey via cosmetics, and in the food and beverage and pharmaceutical industry as an ingredient. The final product 207 is the isolated and sterilized kefir whey which contains nutrients and primary and secondary bioactive metabolites and small amounts of microbe cell fragments from apoptosis.

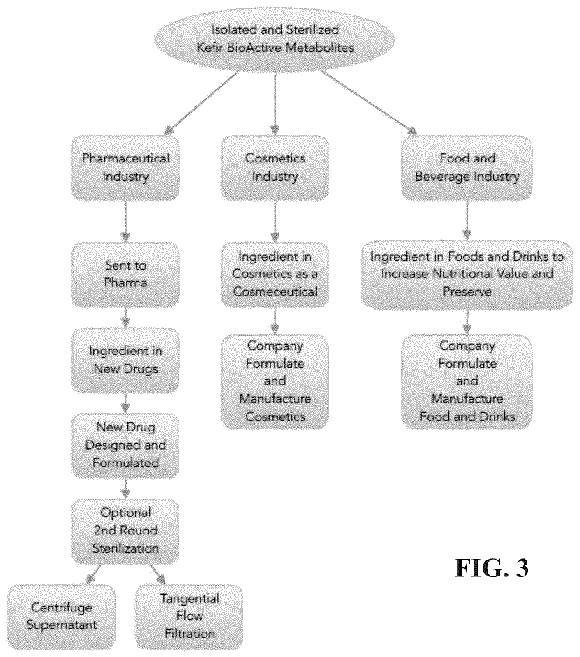

FIG. 3 is a chart illustrating the development of the isolated and sterilized kefir whey product in the pharmaceutical, cosmetic, food and beverage industries. The kefir whey bioactive metabolites product can be a new ingredient to form a new pharmaceutical drug. Optionally a second round of sterilization can be performed on the kefir whey product using pharmaceutical grade techniques and processes. Centrifugation and tangential flow filtration can further isolate the bioactive metabolites that are known to be anti-microbe and anti-cancer bioactive metabolites and utilized in future designed and formulated anti-microbial (anti-biotics) and anti-cancer pharma drugs. The kefir whey product can be an ingredient in cosmetics as a cosmeceutical and can be an ingredient in food and drinks to increase nutritional value and provide food preservation by the anti-microbial bioactive metabolites known as bacteriocins.

The nutrients in Kefir whey include:
Vitamins—B1 (Thiamine), B2, B3 (Niacin) B5 (Pantothenic Acid), B6 (Pyridoxine), B9 (Folic Acid), B12 (Cobalamin), C (Ascorbic Acid), A, K
Minerals—Ca, Mg, P, Na, Iodine, Copper, Zn, Fe
Antioxidants
Vit E—when fermentation is done with whole milk
Proteins—In small amounts

Bioactive Metabolites found in Kefir whey include:
Anti-inflammatory organic acids-SCFA's—increased when fermented with Rice Starch
Anti-inflammatory peptides
Avenanthramides—when fermented with Colloidal Oatmeal or Oat Starch
Saponins—when fermented with Colloidal Oatmeal or Oat Starch
Beta Glucan—when fermented with Colloidal Oatmeal or Oat Starch

Polyphenols—when fermentable fruits are used in fermentation
Hyaluronic Acid
Sphingomyelinase
Anti-Microbial Peptides (Bacteriocins)
Lactic Acid
Anti-Cancer Peptides
Protein derived Primary and Secondary Bioactive Metabolites
Sugar derived Primary and Secondary Bioactive Metabolites

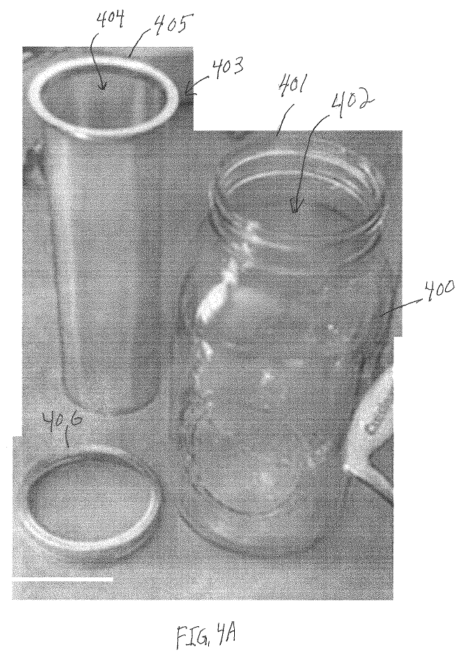

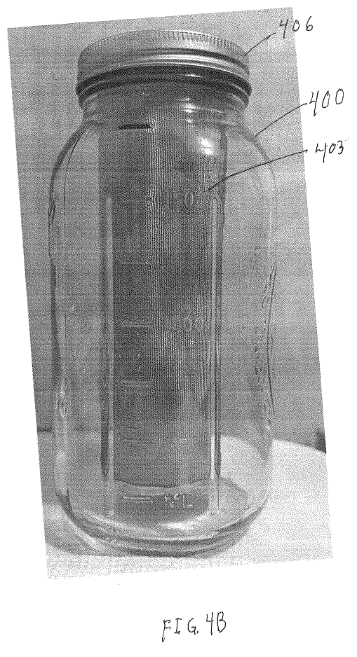

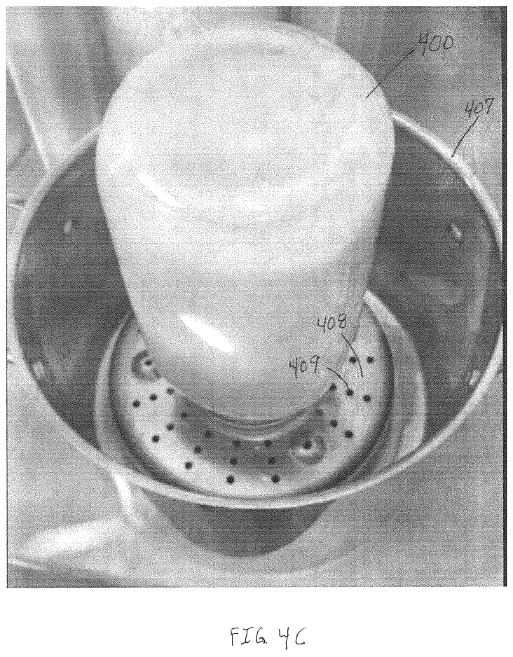

FIG. 4A shows components for an apparatus for isolating whey from kefir. A first container 400 is provided having a top end 401 and an interior 402. A 100 micron filter 403 having an interior 404 is provided with a top end 405 configured to seal the top end 401 of the container 400. An open screw lid 406 is used to fasten the filter 403 in the interior 402 of the first container 400. FIG. 4B shows the 100 micron filter 403 placed in the first container 400 wherein the first container 400 will contain Kefir. The open screw lid 406 is fastened to the top 401 of the first container 400 and seals the 100 micron filter to the top 401 of the first container 400. In this configuration the interior 402 of the first container 400 is closed. The interior 404 of the 100 micron filter is open. FIG. 4C shows the first container 400, having its 100 micron filter 403 in the interior 402, placed inverted into the second container 407 on top of a platform 408 with openings 409. In this configuration the whey in the kefir flows through the 100 micron filter, into the interior 404 of the 100 micron filter 403, out of the top end 405 of the 100 micron filter, and into the second container 407. The curd remains in the first container 400. Although only one first container is shown, many first containers as desired can be placed into a larger second container to extract larger amounts of whey.

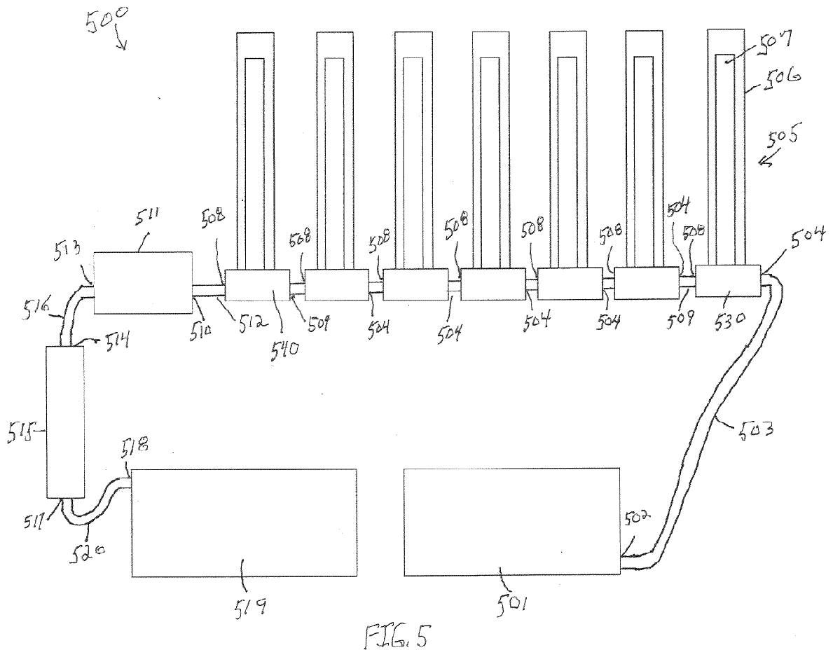

FIG. 5 shows an apparatus 500 for filtering (purifying) and sterilizing the whey separated from the kefir. A whey holding container 501 containing the separated whey has an out port 502 connected to tubing 503 to an input port 504 of a first microfilter system 530. Each microfilter system 505 includes a housing 506 having a microfilter 507 therein. An output port 508 of the microfilter system 505 is connected to an input port 504 of a second adjacent microfilter system 505 with tubing 509. In this manner several microfilter systems 505 can be connected in series. An exit port 508 of the last microfilter system 540 in the series is connected to an input port 510 of a pump 511 with tubing 512. An exit port 513 of the pump 511 is connected to an input port 514 of a UV-C sterilizer 515 with tubing 516. An exit port 517 of the UV-C sterilizer 515 is connected to an input port 518 of a receiving container 519 with tubing 520. The microfilter systems 505 are arranged, preferably, in series from a largest micropore size of the first microfilter system at 25-35 microns to 18-22 microns to 8-12 microns to 4-6 microns to the smallest micropore size of 0.8 to 1.2 microns in the last microfilter system.

The pump 511 draws whey from the holding container 501 through the first microfilter system 530, through the intermediate microfilter systems, and through to the last microfilter system 540. The pump 511 then pushes the whey through the UV-C sterilizer 515 and into the sterilize container 519. Although the pump 511 is, preferably, between the last microfilter system 540 and the UV-C sterilizer 515, the pump may also be placed between the holding container 501 and the first microsystem filter 530 or between the first microfilter system 530 and the last microfilter system 540.

The foregoing description illustrates and describes the method of the disclosure. Additionally, the disclosure shows and describes only the preferred embodiments but as mentioned above, it is to be understood that the preferred embodiments are capable of being formed in various other combinations, modifications, and environments and are capable of changes or modifications within the scope of the invention concepts as expressed herein, commensurate with the above teachings and/or the skill or knowledge of the relevant art. The embodiments described herein above are further intended to explain the best modes known by applicant and to enable others skilled in the art to utilize the disclosure in such, or other, embodiments and with the various modifications required by the particular application or uses thereof. Accordingly, the description is not intended to limit the invention to the form disclosed herein. Also, it is intended that the appended claims be construed to include alternative embodiments. It will be further understood that various changes in the details, materials, and arrangements of the parts which have been described and illustrated above to explain the nature of this invention may be made by those skilled in the art without departing from the principle and scope of the invention as recited in the following claims.

What is claimed is:

1. A method of providing isolated sterilized whey from kefir grains comprising:
1) placing the kefir grains in a vessel;
2) adding a mammalian milk to the vessel in a ratio of 1gallon of mammalian milk per 40 to 60 grams of kefir grains;
3) fermenting the kefir grains for 36 to 56 hours;
4) removing the kefir grains from the vessel and continuing the fermentation 48 to 96 hours;
5) separating the whey from the curd;
6) filtering the whey through a micron filter ranging in pore size from 0.8 to 120 microns; and
7) sterilizing the isolated whey with UV-C light ranging from 100 to 280 nm.

2. The method of claim 1 wherein separating the whey from the curd is performed by removing whey from the bottom of the vessel leaving a remaining curd.

3. The method of claim 2 wherein separating the whey from the remaining curd is performed by filtering the whey from the curd with a filter having a pore size of 80 to 120 microns.

4. The method of claim 1 wherein in the kefir grains of step 1) are obtained from a previous fermentation of kefir grains.

5. The method of claim 1 wherein starch, fermentable foods, or sugars, or a combination thereof are added to the fermentation of Step 3).

6. The method of claim 1 wherein precursor nutrients, starches, whey protein, and sugars are added to the fermentation of Step 4).

7. The method of claim 1 wherein the whey is filtered first through an 80-120 micron filter, then through a 25-35 micron filter, then through an 18-22 micron filter, then through an 8-12 micron filter, then through a 4-6 micron filter, and then through a 0.8 to 1.2 micron filter.

8. The method of claim 3 wherein the whey is filtered through a 25-35 micron filter, then through an 18-22 micron filter, then through a 8-12 micron filter, then through a 4-6 micron filter, and then through a 0.8 to 1.2 micron filter.

9. A method of providing sterilized whey from kefir grains comprising:
1) placing the kefir grains in a vessel;
2) adding a mammalian milk to the vessel in a ratio 1 gallon of mammalian milk per of 40 to 60 grams of kefir grains;
3) fermenting the kefir grains for 36 to 56 hours;
4) removing kefir grains from the vessel and continuing the fermentation 48 to 96 hours;
5) separating the whey from the curd;
6) filtering the whey through a micro filter ranging in pore size from 1 to 100 microns; and
7) sterilizing the isolated whey with UV-C light ranging from 100 to 280 nm,
wherein separating the whey from the curd is performed by removing whey from the bottom of the vessel and
wherein the whey is filtered first through an 80-120 micron filter, then second through a 25-35 micron filter, then third through an 18-22 micron filter, then fourth through an 8-12 micron filter, then fifth through a 4-6 micron filter, and then sixth through a 0.8 to 1.2 micron filter

9. The method of claim 8 wherein in the kefir grains of step 1) are obtained from a previous fermentation of kefir grains.

10. The method of claim 8 wherein starch, fermentable foods, or sugars, or a combination thereof are added to the fermentation of Step 3.

11. The method of claim 8 wherein precursor nutrients, starches, whey protein, and sugars are added to the fermentation of Step 4.

12. A method of providing isolated and sterilized whey from kefir grains comprising:
1) placing the kefir grains in a vessel;
2) adding a mammalian milk to the vessel in a ratio of 1 gallon of mammalian milk per of 40 to 60 grams of kefir grains;
3) fermenting the kefir grains for 36 to 56 hours;
4) removing the kefir grains from the vessel and continuing the fermentation 48 to 96 hours;
5) separating the whey from the curd;
6) filtering the whey through a micro filter ranging in pore size from 48 to 96; and
7) sterilizing the whey with UV-C light ranging from 100 to 280 nm, wherein separating the whey from the remaining curd is performed by filtering the whey from the curd with a filter having a pore size of 80 to 120 microns, and wherein the whey is then filtered first through a 25-35 micron filter, then through an 18-22 micron filter, then through a 8-12 micron filter, then through a 4-6 micron filter, and then through a 0.8 to 1.2 micron filter.

13. The method of claim 12 wherein in the kefir grains of step 1) are obtained from a previous fermentation of kefir grains.

14. The method of claim 12 wherein starch, fermentable foods, or sugars, or a combination thereof are added to the fermentation of Step 3.

15. The method of claim 1 wherein precursor nutrients, starches, whey protein, or fermentable sugars, or a combination thereof are added to the fermentation of Step 4.

16. An apparatus for isolating whey from a mixture of curds and whey, comprising,
a) a first container having a top, a bottom, and an interior wherein the first container contains a mixture of curds and whey;
b) a micron filter having a top, a bottom, and an interior wherein the micron filter is positioned in the interior of the first container; and
c) a sealing member configured to seal the top end of the microfilter to the top end of the first container.
d) a second container having an interior, wherein the first container is positioned in the second container so as to cause whey in the mixture of curds and whey to pass through the micron filter into the interior of the micron filter and into the interior of the second container and wherein the curd remains in the interior of the first container.

17. The apparatus of claim 16, wherein the sealing apparatus closes and seals the top of the first container and leaves the top of the microfilter open.

18. The apparatus of claim 16, wherein the first container is positioned in the second container in an inverted position.

19. An apparatus for filtering and sterilizing whey separated from curd, comprising:
a) a holding container containing the separated whey;
b) the holding container having an output port connected with conduit to an input port of a first microfilter in a series of microfilters;
c) an output port of a last microfilter in the series of microfilters connected with conduit to an input port on a sterilizer;
d) a pump positioned anywhere between the holding container and the receiving container; and
e) an output port on the sterilizer connected to an input port on a receiving container.

20. The apparatus of claim 19 wherein the pore size of the microfilters ranges from 25-35 microns of the first microfilter in the series of microfilters to 0.8 to 1.2 microns of the last microfilter in the series of microfilters.

21. The apparatus of claim 19 wherein the sterilizer is a UV-C light sterilizer.

22. The apparatus of claim 19 wherein the receiving container is sterilized.

23. The apparatus of claim 19 wherein the pump is positioned between the output of the last microfilter in the series and the input of the sterilizer.
